(19) United States
(12) Patent Application Publication
(10) Pub. No.: US 2018/0355823 A1
(43) Pub. Date: Dec. 13, 2018

(54) FLEX JOINT HAVING LINER WITH ARTICULATED JOINT

(71) Applicant: Aerojet Rocketdyne, Inc., Sacramento, CA (US)

(72) Inventor: Dale Cipra, Chatsworth, CA (US)

(21) Appl. No.: 15/762,722

(22) PCT Filed: Oct. 4, 2016
(86) PCT No.: PCT/US16/55267

§ 371 Date: Mar. 23, 2018

Related U.S. Application Data
(60) Provisional application No. 62/239,376, filed on Oct. 9, 2015.

(51) Int. Cl. F02K 9/60; F02K 9/84; F02K 9/44

(52) U.S. Cl. CPC F02K 9/60; F02K 9/84; F02K 9/44; F16L 27/06; F05D 2250/43; F05D 2250/611; F05D 2260/60; F05D 2240/12

(57) ABSTRACT

A flex joint (22) includes a bellows (33) and a liner system (46) disposed in the bellows. The liner system includes two generally cylindrical liner pieces (50,52) that are connected to each other in an articulated joint (54). One of the two generally cylindrical liner pieces defines a ball joint end (56) and the other of the two generally cylindrical liner pieces defines a socket joint end (58). The ball joint end is engaged with the socket joint end to form a ball and socket joint as the articulated joint.

### CROSS-REFERENCE TO RELATED APPLICATIONS

The present disclosure claims priority to U.S. Provisional Patent Application No. 62/239,376 filed Oct. 9, 2015.

### BACKGROUND

Certain rocket engines are designed to be steerable to provide flight trajectory control. For example, the rocket engine may be interconnected with actuators that are operable to gimbal the rocket engine. Propellant feed lines to the rocket engine may include flexible joints to permit the feed lines to gimbal with the engine. The flexible joints may include bellows that can stretch, compress, or angularly displace to provide the required movement.

The bellows has corrugated walls and may be subject to unstable flow regimes in which propellant flow along the internal convolutions produces flow disturbances. One type of disturbance is flow-induced vortex shedding. Flow-induced vortex shedding is an unsteady flow that may occur at particular flow velocities and cause a feedback response that displaces the bellows convolutions and causes high cycle fatigue. Flow velocity may thus be restricted to regimes that have lower potential to generate the flow-induced vortex shedding.

### SUMMARY

A flex joint according to an example of the present disclosure includes a bellows, and a liner system disposed in the bellows. The liner system has two generally cylindrical liner pieces. The two generally cylindrical liner pieces are connected to each other in an articulated joint. One of the two generally cylindrical liner pieces defines a ball joint end and the other of the two generally cylindrical liner pieces defines a socket joint end. The ball joint end is engaged with the socket joint end to form a ball and socket joint as the articulated joint.

A further embodiment of any of the foregoing embodiments includes an additional generally cylindrical liner piece connected in an axial sliding joint with one of the two generally cylindrical liner pieces.

In a further embodiment of any of the foregoing embodiments, the bellows comprises first and second bellows sections. One of the two generally cylindrical liner pieces is primarily disposed within the first bellows section, and the other of the two generally cylindrical liner pieces is primary disposed within the second bellows section.

A further embodiment of any of the foregoing embodiments includes first and second linkages connected, respectively, with the first and second bellows sections.

A further embodiment of any of the foregoing embodiments includes a damper connected between the first and second linkages.

In a further embodiment of any of the foregoing embodiments, the bellows comprises first and second bellows sections. One of the two generally cylindrical liner pieces is primarily disposed within the first bellows section, and the other of the two generally cylindrical liner pieces is primary disposed within the second bellows section.

A further embodiment of any of the foregoing embodiments includes first and second linkages connected, respectively, with the first and second bellows.

A further embodiment of any of the foregoing embodiments includes a damper connected between the first and second linkages.

A rocket engine according to an example of the present disclosure includes a combustion chamber, a nozzle in fluid communication with the combustion chamber, and at least one propellant duct. The propellant duct has a flex joint. The flex joint has a bellows, and a liner system disposed in the bellows. The liner system has two generally cylindrical liner pieces. The two generally cylindrical liner pieces are connected to each other in an articulated joint. One of the two generally cylindrical liner pieces defines a ball joint end and the other of the two generally cylindrical liner pieces defines a socket joint end. The ball joint end is engaged with the socket joint end to form a ball and socket joint as the articulated joint.

A further embodiment of any of the foregoing embodiments includes an additional generally cylindrical liner piece connected in an axial sliding joint with one of the two generally cylindrical liner pieces.

In a further embodiment of any of the foregoing embodiments, the bellows comprises first and second bellows sections. One of the two generally cylindrical liner pieces is primarily disposed within the first bellows section, and the other of the two generally cylindrical liner pieces is primary disposed within the second bellows section.

A further embodiment of any of the foregoing embodiments includes first and second linkages connected, respectively, with the first and second bellows sections.

A further embodiment of any of the foregoing embodiments includes a damper connected between the first and second linkages.

In a further embodiment of any of the foregoing embodiments, the bellows comprises first and second bellows sections. One of the two generally cylindrical liner pieces is primarily disposed within the first bellows section, and the other of the two generally cylindrical liner pieces is primary disposed within the second bellows section.

A further embodiment of any of the foregoing embodiments includes first and second linkages connected, respectively, with the first and second bellows.

A further embodiment of any of the foregoing embodiments includes a damper connected between the first and second linkages.

A flex joint according to an example of the present disclosure includes a bellows, and a liner system that has a first liner piece disposed in the bellows. The first liner piece has a first liner spherical joint end. A second liner piece is disposed in the bellows. The second liner piece has a second liner cylindrical end. An intermediate liner piece joins the first and second liner pieces. The intermediate liner piece has an intermediate liner spherical joint end and an intermediate liner cylindrical end. The intermediate liner spherical joint end conforms with the first liner spherical joint end, and the intermediate liner cylindrical end conforms with the second liner cylindrical end.

In a further embodiment of any of the foregoing embodiments, the intermediate liner cylindrical end is slidable with respect to the second liner cylindrical end.

In a further embodiment of any of the foregoing embodiments, one of the intermediate liner spherical joint end and the first liner spherical joint end includes a convex spherical surface, and the other of the intermediate liner spherical joint end and the first liner spherical joint end includes a concave spherical surface.

In a further embodiment of any of the foregoing embodiments, each of the first liner piece, the second liner piece, and the intermediate liner piece has a cylindrical section with a constant circular cross-section.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example rocket engine.

FIG. 2 illustrates selected portions of an example flex joint of the rocket engine of FIG. 1.

FIG. 3A illustrates selected portions of a liner system of the flex joint of the FIG. 2.

FIG. 3B illustrates another view of the liner system.

FIG. 4A illustrates another example liner system.

FIG. 4B illustrates the liner system of FIG. 4A in a tilted position.

FIG. 5 illustrates another example flex joint that has a single bellows.

### DETAILED DESCRIPTION

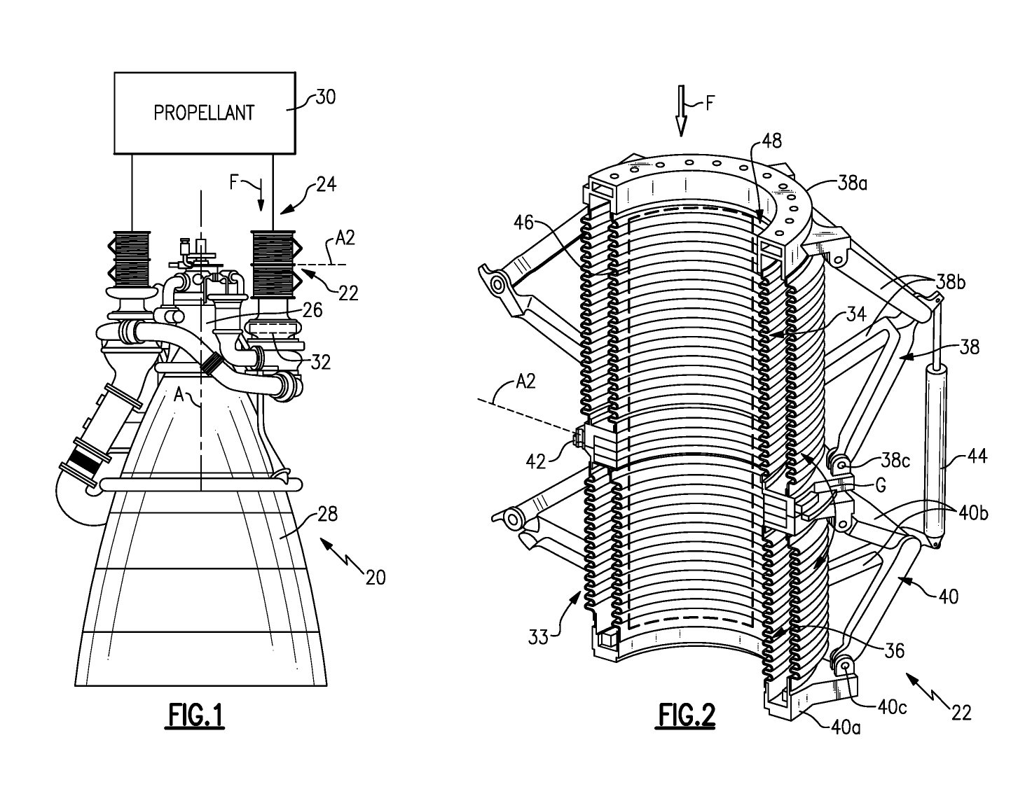

FIG. 1 schematically illustrates an example rocket engine 20. As an example, the rocket engine 20 may be interconnected in a known manner with actuators (not shown) to allow capability to gimbal the rocket engine 20 for flight trajectory control. In this regard, the rocket engine 20 includes one or more flex joints 22 located in one or more propellant lines or ducts 24 for providing propellant to the rocket engine 20.

In this example, the rocket engine 20 includes a combustion chamber 26 and a nozzle 28 in fluid communication with the combustion chamber 26. The one or more propellant ducts 24 are connected to one or more propellant sources 30 for delivering propellant to the combustion chamber 26 to generate thrust. In this example, the rocket engine 20 includes an inducer 32 in one of the propellant ducts 24 downstream of the flex joint 22 to facilitate flow of propellant to the combustion chamber 26.

The rocket engine 20 may tilt angularly with respect to central axis A (of the vehicle which the rocket engine 20 propels) to provide flight trajectory control. In this regard, each such flex joint 22 provides flexibility in the given propellant duct 24 to move with the rocket engine 20. Although the examples herein describe the flex joint or joints 22 in the rocket engine 20, it is to be understood that other types of rockets, other types of engines or propulsors, other machines, or other fluid communication lines may also benefit from this disclosure.

FIG. 2 shows a sectioned view of selected portions of an example of the flex joints 22. In this example, the flex joint 22 includes a bellows 33 that has a first bellows section 34 and a second bellows section 36. For instance, the bellows sections 34/36 are formed of corrugated metal or other material that is capable of bending, twisting, compressing, and elongating because of the convolutions of the corrugations. In this example, the bellows sections 34/36 are generally cylindrical but have a non-constant cross-sectional area because of the convolutions.

The flex joint 22 may include a first linkage 38 connected with the exterior of the first bellows section 34 and a second linkage 40 connected with the exterior of the second bellows section 36. As is known, such linkages 38/40 may include one or more rings 38a/40a and intermediate rings 42 that are secured to the bellows sections 34/36, and a plurality of support arms 38b/40b that are pivotably interconnected via pivot pins 38c/40c. The linkages 38/40 may be operated in a known manor using actuators to angularly tilt the flex joint 22 about axis A2, as generally represented at G.

A damper 44, such as a hydraulic or mechanical damper, may be connected between the first and second linkages 38/40 external of the bellows sections 34/36 to dissipate energy and vibrational movement of the bellows sections 34/36. A liner system 46 is disposed in the bellows 33, such as in an interior 48 of the first and second bellows sections 34/36.

As represented at F, propellant flows through the flex joint 22 and liner system 46. The liner system 46 may be formed of, but is not limited to, a metal alloy. The liner system 46 shields the convolutions of the bellows sections 34/36 from the flow and thus reduces or eliminates the potential for flow disturbances from flow interaction with the convolutions, such as flow-induced vortex shedding.

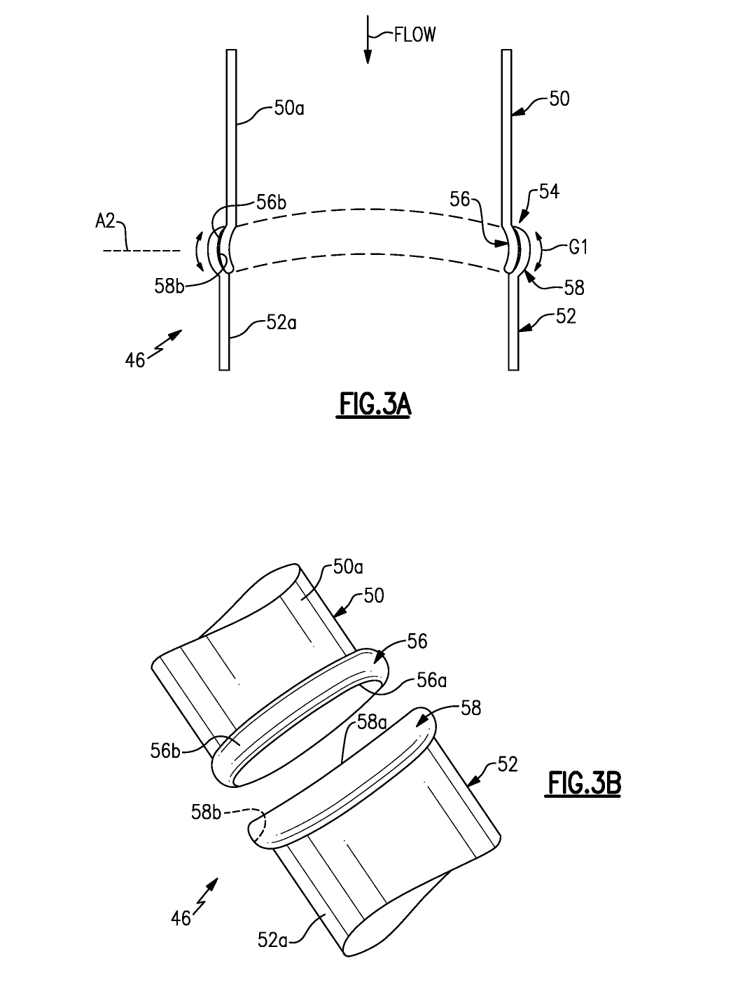

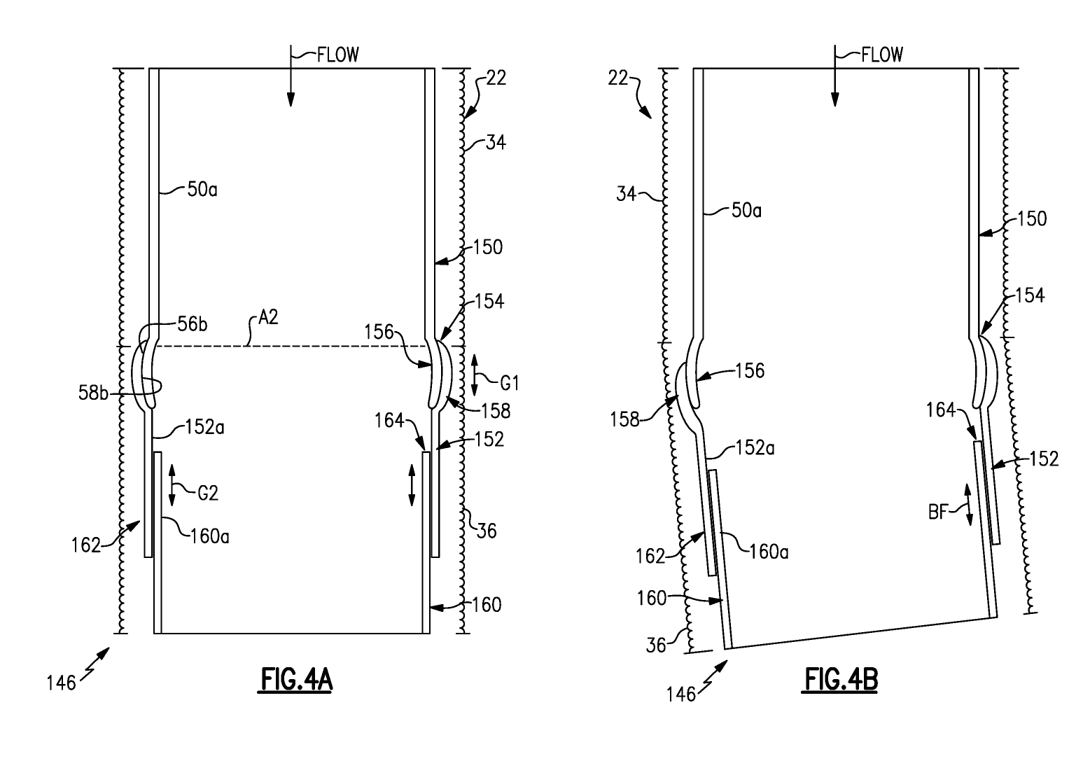

The flex joint 22 is capable of pivoting about axis A2, for example. Thus, the liner system 46 must also be able to pivot or move with the bellows 33. FIGS. 3A and 3B show selected portions of the liner system 46. As the bellows sections 34/36 tilt angularly about axis A2, the liner system 46 pivots to move with the bellows sections 34/36. In this example, the liner system 46 includes two generally cylindrical liner pieces 50/52. The liner piece 50 includes a cylindrical section 50a that has a constant circular cross-section, and the liner piece 52 includes a cylindrical section 52a that also has a constant circular cross-section. The liner pieces 50/52 are connected to each other in an articulated joint 54. For example, the articulated joint 54 is a joint in which the liner pieces 50/52 are mechanically coupled together such that the liner pieces 50/52 can pivot relative to one another at the at the mechanical couple (e.g., about axis A2). The liner system 46 can thus move with the bellows 33.

In this example, the articulated joint 54 is a ball and socket type joint. In this regard, the liner piece 50 includes a ball joint end 56, and the liner piece 52 includes a socket joint end 58. For instance, although not limited, the end of the liner piece 50 is formed into the shape of the ball joint end 56 and the end of the liner piece 52 is formed into the socket joint end 58. The ball joint end 56 is engaged with and may conform with the socket joint end 58 to form a ball and socket joint as the articulated joint 54. The ball and socket joint permits relative movement and sealing between the liner pieces 50/52 about axis A2, as generally represented at G1. Although the liner piece 50 in this example includes the ball joint end 56 and the liner piece 52 includes the socket joint end 58, the liner piece 50 could alternatively include the socket joint end 58 and the liner piece 52 could include the ball joint end 56.

As shown in FIG. 3B, the ball joint end 56 includes an annulus 56a that has a convex spherical surface 56b and the socket joint end 58 includes a corresponding annulus 58a that has a concave spherical surface 58b. Each of the convex spherical surface 56b and the concave spherical surface 58b are partial spherical toroid surfaces.

The concave spherical surface 58b may conform with the convex spherical surface 56b to form the ball and socket joint. Thus, when the flex joint 22 is actuated to tilt the second bellows section 36 relative to the first bellows section 34 about axis A2, the liner system 46 can pivot about the ball and socket joint to move with the bellows sections 34/36, yet still fully shield the convolutions of the bellows sections 34/36. In this regard, the convex spherical surface 58b may be in contact with and slide along the concave spherical surface 56b during pivoting movement. A lubricant or lubricious coating can be provided in the articulated joint 54 to reduce wear, although such measures may not be needed for single use or limited use rocket engines. As will be appreciated, the sizes of the convex spherical surface 58b and the concave spherical surface 58b may be designed with regard to the expected amount of movement such that interference between the annulus 58a and the cylindrical section 50a is substantially avoided.

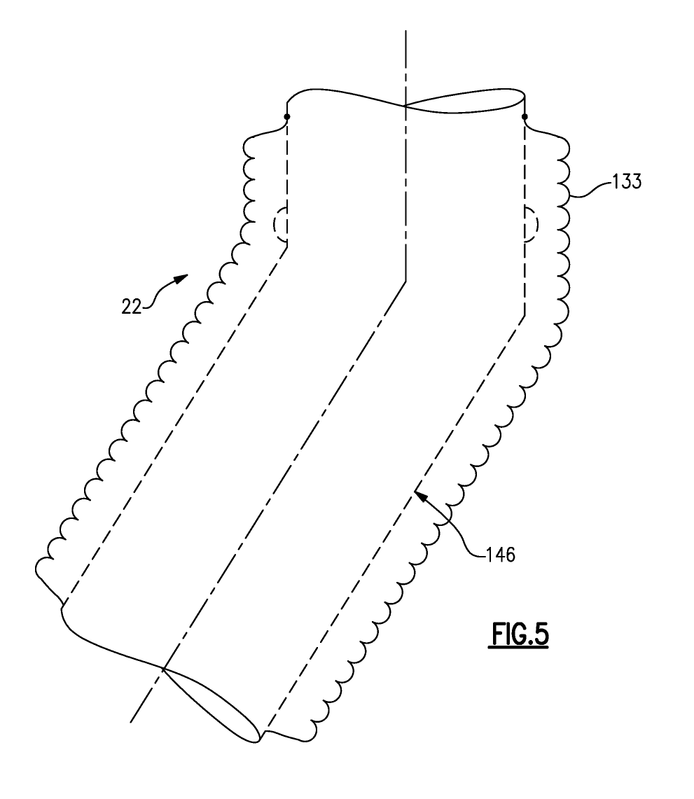

FIGS. 4A and 4B illustrate another example liner system 146. In this disclosure, like reference numerals designate like elements where appropriate and reference numerals with the addition of one-hundred or multiples thereof designate modified elements that are understood to incorporate the same features and benefits of the corresponding elements. As described, the flex joint 22 is capable of pivoting about axis A2. The flex joint 22 may also shorten and lengthen as it pivots (e.g., a scissor duct). Thus, in addition to pivoting, the liner system 146 must also be able to shorten/lengthen. Such compound movement, in combination with full shielding of a bellows, is particularly challenging to address because designs that would permit compound movement would not typically provide full shielding and designs for full shielding would not typically permit compound movement. The liner system 146 permits full shielding and compound movement.

In this example, the liner system 146 includes a first liner piece 150, a second liner piece 160, and an intermediate liner piece 152. The first liner piece 150 includes a first liner spherical joint end 156. The second liner piece 160 has second liner cylindrical end 160a. The intermediate liner piece 152 has an intermediate liner spherical joint end 158 and an intermediate liner cylindrical end 152a that has a constant circular cross-section. The intermediate liner piece 152 joins the first and second liner pieces 150/160. The intermediate spherical joint end 158 conforms with the liner spherical joint end 156 to form an articulated joint 154. The intermediate liner cylindrical end 152a conforms with the second liner cylindrical end 160a of the second liner piece 160 to form an axial sliding joint 162.

The first liner piece 150 and the intermediate liner piece 152 can pivot (e.g., about axis A2) about the articulated joint 154. The intermediate liner piece 152 and the second liner piece 160 are axially moveable relative to each other along the axial sliding joint 162, as generally represented at G2. Thus, as depicted in FIG. 4B, when the flex joint 22 bends or pivots about axis A2, the intermediate liner piece 152 pivots at the articulated joint 154 and the second liner piece 160 slides in the axial sliding joint 162 so that the liner system 146 shortens or lengthens with the bellows sections 34/36, yet maintains full shielding of the convolutions of the bellows sections 34/36 and good sealing of the flow F.

Because of the pivoting of the intermediate liner piece 152, the second liner piece 160 partially pivots. The partial pivot movement causes non-uniform axial movement in the axial sliding joint 162 in which a portion of the second liner cylindrical end 160a retracts from the intermediate liner cylindrical end 152a (lengthens) and an opposite portion of the second liner cylindrical end 160a extends into the intermediate liner cylindrical end 152a (shortens). The liner system 146 thus permits full shielding and compound movement (pivoting and shortening/lengthening).

In the illustrated example, the second liner cylindrical end 160a of the second liner piece 160 is radially inboard of the intermediate liner cylindrical end 152a of the intermediate liner piece 152. Thus, the second liner cylindrical end 160a and the intermediate liner cylindrical end 152a define a step 164. The step 164 faces toward the articulated joint 154, which is also into the flow F of propellant through the liner system 146. As mentioned above, the rocket engine 20 includes an impeller 32 downstream of the flex joint 22. Under certain conditions, the impeller 32 can cause a backflow, BF, of propellant through the liner system 146. Such backflow is generally along the walls of the liner system 146 in a direction opposite the flow F of the propellant. A step facing into the backflow has the potential to interfere with and impede the backflow. However, since the step 164 faces toward the articulated joint 154 and into the flow F, the step 164, does not impede the backflow. Even so, since the liner system 146 shields the convolutions and facilitates the flow F through the flex joint 22, the flow F may be optimized or adjusted to a greater extent to mitigate the conditions that may cause backflow. Therefore, the backflow may be reduced or eliminated using the liner system 146. Alternatively, if such an impediment to the back flow is not of concern or is tolerable in a given design, the second liner cylindrical end 160a may be radially outboard of the intermediate liner cylindrical end 152a such that the step faces the other way (i.e., faces downstream).

FIG. 5 illustrates another example of the flex joint 22. In FIG. 2 the bellows 33 has the first and second bellows sections 34/36. However, the example of FIG. 5 includes a bellows 133 that is a single bellows or single bellows section. For instance, the bellows 133 is a single continuous bellows that does not have sections that are joined by rings or the like. Although shown with liner system 46, it is to be appreciated that the liner system 146 may also be used with the bellows 133. Additionally, the flex joint 22 in this example does not include linkages 38/40, damper 40, or the related components therewith, and may this be considered a “pure angulation” flex joint.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A flex joint comprising:
a bellows; and
a liner system disposed in the bellows, the liner system including two generally cylindrical liner pieces, the two generally cylindrical liner pieces being connected to each other in an articulated joint, wherein one of the two generally cylindrical liner pieces defines a ball joint end and the other of the two generally cylindrical liner pieces defines a socket joint end, the ball joint end being engaged with the socket joint end to form a ball and socket joint as the articulated joint.

2. The flex joint as recited in claim 1, further comprising an additional generally cylindrical liner piece connected in an axial sliding joint with one of the two generally cylindrical liner pieces.

3. The flex joint as recited in claim 2, wherein the bellows comprises first and second bellows sections, wherein one of the two generally cylindrical liner pieces is primarily disposed within the first bellows section, and the other of the two generally cylindrical liner pieces is primary disposed within the second bellows section.

4. The flex joint as recited in claim 3, further comprising first and second linkages connected, respectively, with the first and second bellows sections.

5. The flex joint as recited in claim 4, further comprising a damper connected between the first and second linkages.

6. The flex joint as recited in claim 1, wherein the bellows comprises first and second bellows sections, wherein one of the two generally cylindrical liner pieces is primarily disposed within the first bellows section, and the other of the two generally cylindrical liner pieces is primary disposed within the second bellows section.

7. The flex joint as recited in claim 6, further comprising first and second linkages connected, respectively, with the first and second bellows.

8. The flex joint as recited in claim 7, further comprising a damper connected between the first and second linkages.

9. A rocket engine comprising:
a combustion chamber;
a nozzle in fluid communication with the combustion chamber; and
at least one propellant duct, the at least one propellant duct including a flex joint, the flex joint including:
a bellows, and
a liner system disposed in the bellows, the liner system including two generally cylindrical liner pieces, the two generally cylindrical liner pieces being connected to each other in an articulated joint, wherein one of the two generally cylindrical liner pieces defines a ball joint end and the other of the two generally cylindrical liner pieces defines a socket joint end, the ball joint end being engaged with the socket joint end to form a ball and socket joint as the articulated joint.

10. The rocket engine as recited in claim 9, further comprising an additional generally cylindrical liner piece connected in an axial sliding joint with one of the two generally cylindrical liner pieces.

11. The rocket engine as recited in claim 10, wherein the bellows comprises first and second bellows sections, wherein one of the two generally cylindrical liner pieces is primarily disposed within the first bellows section, and the other of the two generally cylindrical liner pieces is primary disposed within the second bellows section.

12. The rocket engine as recited in claim 11, further comprising first and second linkages connected, respectively, with the first and second bellows sections.

13. The rocket engine as recited in claim 12, further comprising a damper connected between the first and second linkages.

14. The rocket engine as recited in claim 9, wherein the bellows comprises first and second bellows sections, wherein one of the two generally cylindrical liner pieces is primarily disposed within the first bellows section, and the other of the two generally cylindrical liner pieces is primary disposed within the second bellows section.

15. The flex joint as recited in claim 14, further comprising first and second linkages connected, respectively, with the first and second bellows.

16. The flex joint as recited in claim 15, further comprising a damper connected between the first and second linkages.

17. A flex joint comprising:
a bellows; and
a liner system including:
a first liner piece disposed in the bellows, the first liner piece having a first liner spherical joint end,
a second liner piece disposed in the bellows, the second liner piece having a second liner cylindrical end, and
an intermediate liner piece joining the first and second liner pieces, the intermediate liner piece having an intermediate liner spherical joint end and an intermediate liner cylindrical end, the intermediate liner spherical joint end conforming with the first liner spherical joint end, and the intermediate liner cylindrical end conforming with the second liner cylindrical end.

18. The flex joint as recited in claim 17, wherein the intermediate liner cylindrical end is slidable with respect to the second liner cylindrical end.

19. The flex joint as recited in claim 17, wherein one of the intermediate liner spherical joint end and the first liner spherical joint end includes a convex spherical surface, and the other of the intermediate liner spherical joint end and the first liner spherical joint end includes a concave spherical surface.

20. The flex joint as recited in claim 17, wherein each of the first liner piece, the second liner piece, and the intermediate liner piece has a cylindrical section with a constant circular cross-section.
